(19) United States
(12) Patent Application Publication
(10) Pub. No.: US 2015/0274217 A1
(43) Pub. Date: Oct. 1, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Joel Colombo, Howell, MI (US); Steven E. Morris, Fair haven, MI (US); Jennifer P. Lawall, Waterford, MI (US); Ashish M. Gollapalli, Sterling Heights, MI (US)

(73) Assignee: GM GLOBAL TECHNOLOGY OPERATIONS LLC, Detroit, MI (US)

(21) Appl. No.: 14/231,395

(22) Filed: Mar. 31, 2014

(51) Int. Cl. B62D 27/02; B62D 27/06

(52) U.S. Cl. CPC B62D 27/02; B62D 27/06

(57) ABSTRACT

In one aspect, an elastically averaged alignment system includes a first component having an interior cavity and a pair of opposed alignment members positioned at least partially within the interior cavity, a second component having an inner wall defining a pair of opposed alignment apertures, each alignment aperture configured to receive one of the alignment members to couple the first component and the second component, and a third component seated within the interior cavity. The alignment member is an elastically deformable material such that when the opposed alignment members are inserted into the opposed alignment apertures (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

### FIELD OF THE INVENTION

The subject invention relates to matable components and, more specifically, to elastically averaged matable components for alignment and retention.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

Significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling.

### SUMMARY OF THE INVENTION

In one aspect, an elastically averaged alignment system is provided. The system includes a first component having an interior cavity and a pair of opposed alignment members positioned at least partially within the interior cavity, a second component having an inner wall defining a pair of opposed alignment apertures, each alignment aperture configured to receive one of the alignment members to couple the first component and the second component, and a third component seated within the interior cavity. The alignment member is an elastically deformable material such that when the opposed alignment members are inserted into the opposed alignment apertures (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

In another aspect, a vehicle is provided. The vehicle includes a body and an elastically averaged alignment system integrally arranged within the body. The elastically averaged alignment system includes a first component having an interior cavity and a pair of opposed alignment members positioned at least partially within the interior cavity, a second component having an inner wall defining a pair of opposed alignment apertures, each alignment aperture configured to receive one of the alignment members to couple the first component and the second component, and a third component seated within the interior cavity. The alignment member is an elastically deformable material such that when the opposed alignment members are inserted into the opposed alignment apertures (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

In yet another aspect, a method of manufacturing an elastically averaged alignment system is provided. The method includes fabricating a first component having in interior cavity and a pair of opposed alignment member positioned at least partially within the interior cavity, and providing a second component comprising an inner wall defining a pair of opposed alignment apertures, each alignment aperture configured to receive one of the alignment members to couple the first component and the second component. The method further includes fabricating a third component, seating the third component within the interior cavity, and fabricating the alignment member from an elastically deformable material such that when the opposed alignment members are inserted into the opposed alignment apertures, (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaging mating system before assembly;

FIG. 2 is a perspective view of the system shown in FIG. 1 after assembly;

FIG. 3 is a cross-sectional view of the system shown in FIG. 2 taken along section 3-3 and in a closed position with an open position shown in phantom;

FIG. 4 is a cross-sectional view of an alternate embodiment of the alignment members of the system shown in FIGS. 1-3; and

FIG. 5 is a front view of a vehicle that may use the elastically averaged alignment system shown in FIGS. 1-4.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior, electrical and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are elastic averaging alignment systems and methods. The alignment systems include a component with alignment aperture(s) to receive elastically deformable alignment member(s) of another component. An additional component is inserted within an interior cavity of the component with the alignment aperture(s). The alignment member(s) is configured to be inserted into one alignment aperture(s), and the alignment member(s) elastically deforms to facilitate precisely aligning and securing the components together in a desired orientation.

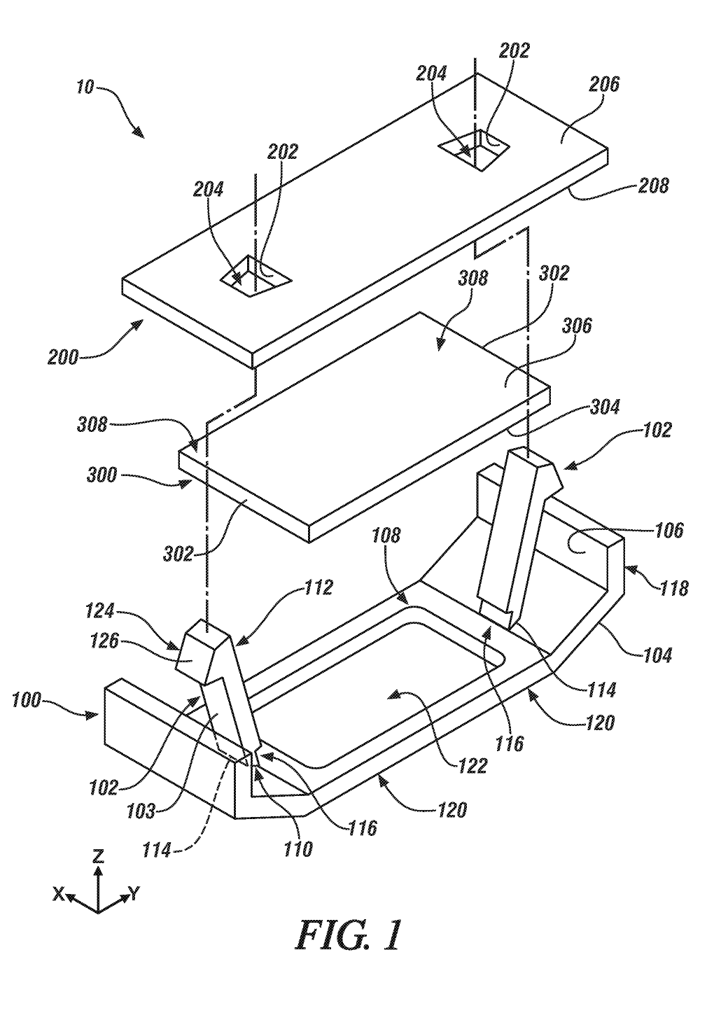

FIGS. 1-3 illustrate an exemplary elastically averaged alignment system 10 that generally includes a first component 100 to be mated to a second component 200 and a third component 300.

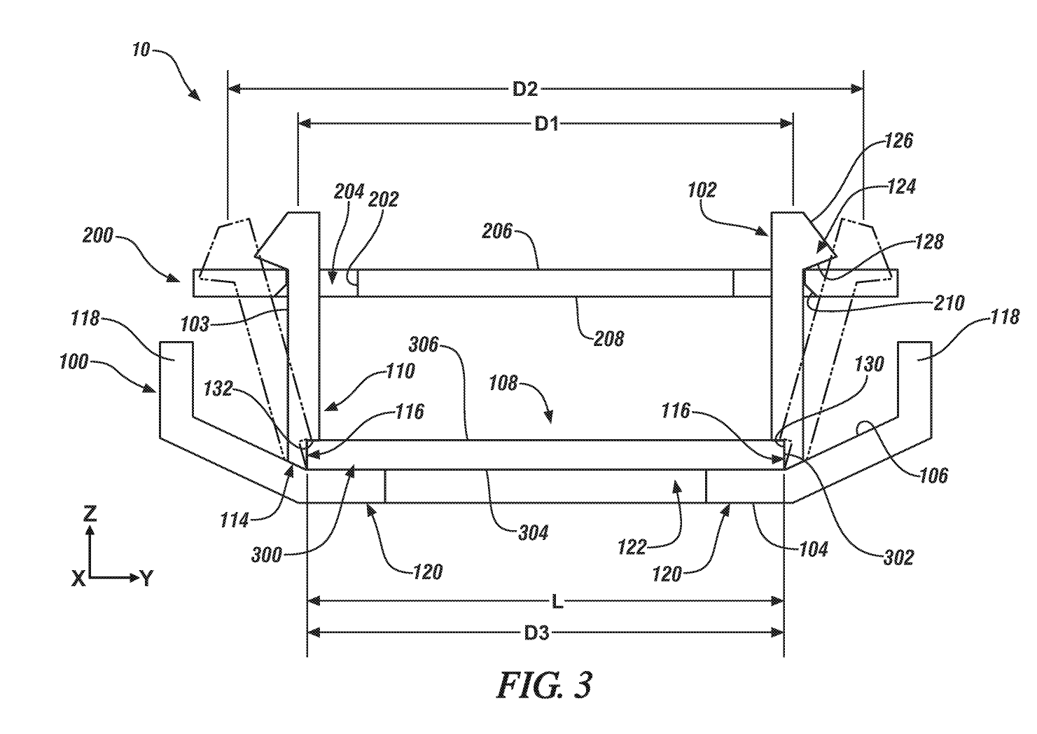

In the exemplary embodiment, first component 100 includes opposed elastically deformable alignment clips or members 102, and second component includes an inner wall 202 defining opposed alignment apertures 204. Alignment members 102 and alignment apertures 204 are fixedly disposed on or formed integrally with their respective component 100, 200 for proper alignment and orientation when components 100 and 200 are mated. In an open, unmated position, alignment members 102 are oriented angularly outward from each other (FIG. 1); and in a closed, mated position, alignment members are elastically deformed toward each other (FIG. 3; an open position in phantom) and may be oriented substantially parallel to each other, as is described herein in more detail. Although two alignment members 102 and corresponding alignment apertures 204 are illustrated in FIG. 1, components 100 and 200 may have any number and combination of corresponding alignment members 102 and alignment apertures 204.

Elastically deformable alignment members 102 are configured and disposed to interferingly, deformably, and matingly engage alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Alignment members 102 are also configured and disposed to interferingly, deformably, and matingly engage third component 300, as discussed herein in more detail, to precisely align first component 100 and third component 300 in two or four directions (e.g., +/−x-direction and the +/−y-direction of an orthogonal coordinate system). Moreover, elastically deformable alignment members 102 matingly engage alignment apertures 204 and third component 300 to facilitate a stiff and rigid connection between first component 100 and second component 200 and between first component 100 and third component 300, thereby reducing or preventing relative movement therebetween.

In the exemplary embodiment, first component 100 generally includes an outer face 104 and an inner face 106 from which alignment member 102 extends. Inner face 106 and/or alignment member 102 define an interior cavity 108, and alignment member 102 is disposed at least partially within interior cavity 108. Alignment member 102 is a generally rectangular, solid member having a proximal end 110 coupled to inner face 106, and a distal end 112. However, alignment member 102 may have any cross-sectional shape that enables system 10 to function as described herein.

Alignment member proximal end 110 includes a living hinge 114 coupled to inner face 106, and a notch 116 configured to receive a portion of third component 300. First component 100 includes an outer flange 118 and an inner flange 120 that defines an aperture 122. Alignment member distal end 112 includes a retention member 124 extending outwardly from an alignment member outer surface 103 and configured to engage second component 200. In the exemplary embodiment, first component 100 is fabricated from a rigid material such as plastic. However, first component 100 may be fabricated from any suitable material that enables system 10 to function as described herein.

Second component 200 generally includes an outer face 206 and an inner face 208. In the exemplary embodiment, alignment apertures 204 are illustrated as having a generally trapezoidal cross-section. Alternatively, alignment apertures 204 may have any shape that enables system 10 to function as described herein. In the exemplary embodiment, second component 200 is fabricated from a rigid material such as sheet metal. However, second component 200 may be fabricated from any suitable material that enables system 10 to function as described herein.

In the exemplary embodiment, third component 300 generally includes an outer edge 302, an outer face 304, and an inner face 306. Although third component 300 is illustrated as generally rectangular, third component 300 may have any suitable shape that enables system 10 to function as described herein. In the exemplary embodiment, third component 300 is fabricated from a rigid material such as plastic. However, third component 300 may be fabricated from any suitable material that enables system 10 to function as described herein.

While not being limited to any particular structure, first component 100 may be a bezel or an intermediate component of a vehicle with the customer-visible side being outer face 104. Second component 200 may be a supporting substructure that is part of, or is attached to, the vehicle and on which first component 100 is fixedly mounted in precise alignment. Component 300 may be a decorative insert or trim component with the customer-visible side being outer face 304.

To provide an arrangement where elastically deformable alignment member 102 is configured and disposed to interferingly, deformably and matingly engage alignment aperture 204, a distance “D1” between opposed alignment apertures 204 is less than a distance “D2” between opposed alignment members 102 when in the open position (FIG. 1, FIG. 3 outlined members 102), which necessarily creates a purposeful interference fit between the elastically deformable alignment member 102 and alignment aperture 204. Further, second component 200 may include a chamfer 210, FIG. 3, to facilitate insertion of alignment member 102 into alignment aperture 204. As such, when inserted into alignment aperture 204, portions of the elastically deformable alignment member 102 elastically deform to an elastically averaged final configuration that aligns alignment member 102 with the alignment aperture 204 in two or four planar orthogonal directions (the +/−x-direction and the +/−y-direction).

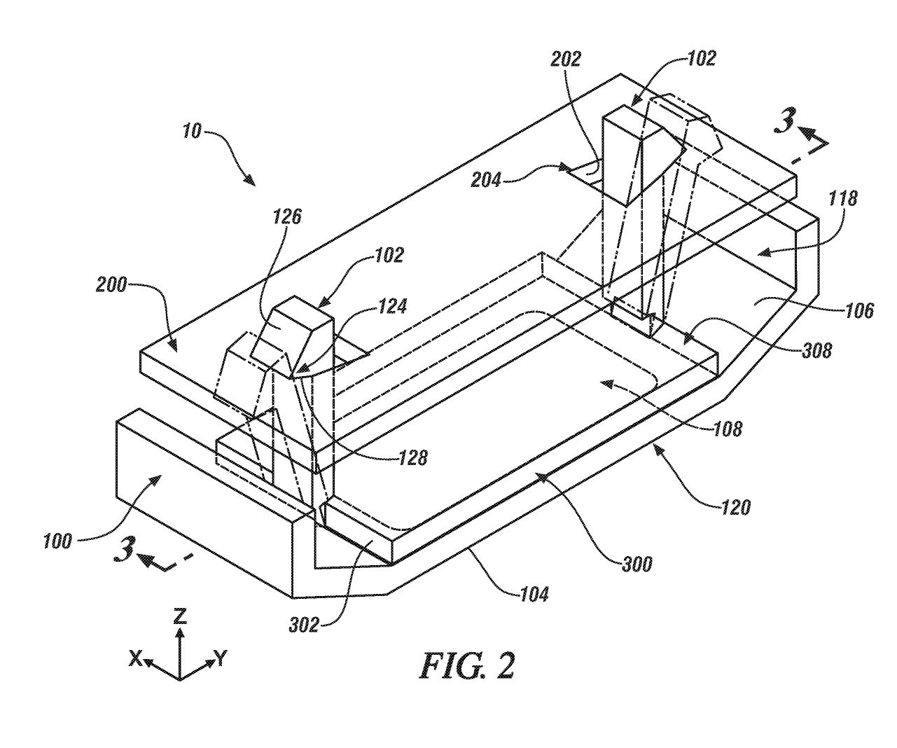

To provide an arrangement where elastically deformable alignment member 102 is configured and disposed to interferingly, deformably and matingly engage third component 300, a distance “D3” between opposed alignment member notches 116 (when members 102 are in the closed position) is less than or equal to a length “L” of third component 300, which necessarily creates a purposeful interference fit between the elastically deformable alignment members 102 and third component 300. As such, when third component 300 is inserted into interior cavity 108 and opposed alignment members 102 are forced toward each other to the closed position (FIGS. 2 and 3), portions of the elastically deformable alignment member 102 elastically deform to an elastically averaged final configuration that aligns third component 300 with first component 100 in two or four planar orthogonal directions (the +/−x-direction and the +/−y-direction). As such, in the exemplary embodiment, at least a portion of outer face 304 is visible through aperture 120. Accordingly, both second component 200 and third component 300 are precisely aligned with first component 100 using common alignment members 102.

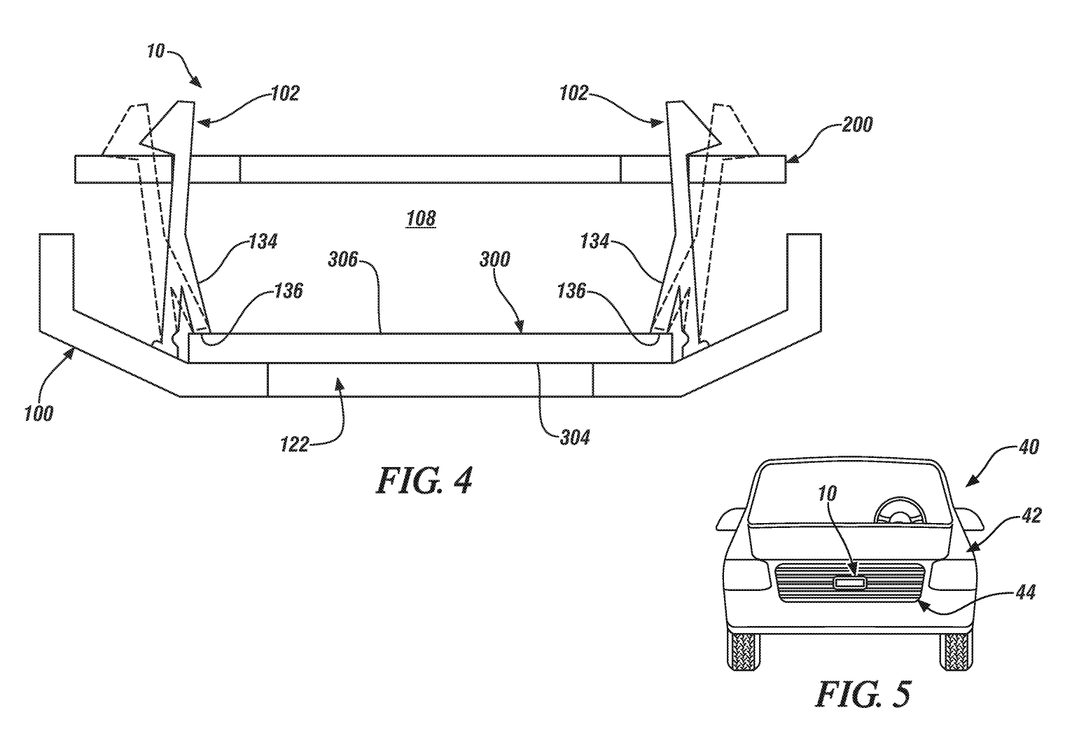

As shown in FIG. 3, alignment members 102 include retention member 124 to facilitate retention of alignment member 102 within alignment aperture 204. In the exemplary embodiment, retention member 124 includes an insertion surface 126 and a retention surface 128. Insertion surface 126 extends angularly from alignment member outer surface 103 and facilitates insertion of alignment member 102 into alignment aperture 204. After insertion, retention surface 128 engages outer face 206 to facilitate preventing alignment member 102 from backing out or otherwise being removed from alignment aperture 204. In the exemplary embodiment, retention member 124 has a triangular cross-section. Alternatively, retention member 124 may have any suitable shape that enables system 10 to function as described herein. Accordingly, retention member 124 facilitates improved retention of alignment members 102 within alignment apertures 204. As shown in FIG. 4, alignment member 102 may include one or more support member 134 extending angularly therefrom. When in the closed position, a support member end surface 136 abuts against third component inner face 306 to facilitate securing third component 300 within interior cavity 108 in the +/−z-direction.

While FIGS. 1-4 depict two opposed elastically deformable alignment members 102 for corresponding alignment apertures 204 to provide two/four-way alignment of first component 100 relative to second component 200, it will be appreciated that the scope of invention is not so limited and encompasses other quantities and types of elastically deformable alignment elements used in conjunction with the elastically deformable alignment member 102 and corresponding alignment aperture 204. Moreover, third component 300 may include any number of individual elements that together comprise third component 300.

In an exemplary construction, third component 300 is inserted into interior cavity 108 between opposed alignment members 102 such that outer edges 302 are oriented proximate an alignment member notch 116. First component 100 is coupled to second component 200 by inserting each alignment member 102 into a corresponding alignment aperture 204. Accordingly, opposed alignment members 102 are forced to rotate toward each other about living hinge 114, due to distance “D1” being less than distance “D2”. As such, alignment members 102, particularly distal ends 112, are elastically deformed and forced toward each other by alignment aperture 204, thereby precisely aligning components 100 and 200.

Additionally, rotation of alignment members 102 about living hinge 114 facilitates securing third component 300 within interior cavity 108. In this way, alignment apertures 204 force alignment members 102 toward each other such that notch 116 is brought down around third component ends 308 to secure third component 300 therebetween. Accordingly, third component 300 is secured within interior cavity 108 such that outer edge 302 abuts against a first notch surface 130, inner face 306 abuts against a second notch surface 132, and/or a portion of outer face 304 abuts against inner flange 120. Because the length or cross-section of third component 300 is equal to or larger than that of interior cavity 108 between opposed alignment members 102, alignment members 102, particularly proximal ends 110, are elastically deformed outward toward respective outer flanges 116.

In view of the foregoing, and with reference now to FIG. 5, it will be appreciated that an embodiment of the invention also includes a vehicle 40 having a body 42 with an elastically averaging alignment system 10 as herein disclosed integrally arranged with the body 42. In the embodiment of FIG. 5, elastically averaging alignment system 10 is depicted forming at least a portion of a front grill 44 of the vehicle 40. However, it is contemplated that an elastically averaging alignment system 10 as herein disclosed may be utilized with other multi-layered components of the vehicle 40, such as interior trim inserts, exterior trim bezels and inserts, instrument panel decorative trim, compartment multi-layer doors, and console trim.

An exemplary method of fabricating elastically averaged alignment system 10 includes forming first component 100 with at least one pair of opposed alignment members 102, forming or providing second component with inner wall 202 defining at least one pair of opposed alignment apertures 204, and forming third component 300. Alignment members 102 are formed to be elastically deformable such that when alignment members 102 are inserted into respective alignment apertures 204, alignment member 102 elastically deforms to an elastically averaged final configuration to facilitate aligning first component 100 and second component 200 in a desired orientation. Additionally, alignment members 102 elastically deform to the elastically averaged final configuration to facilitate securing third component 300 within interior cavity 108 and aligning first component 100 and third component 300 in a desired orientation. Alignment members 102 are formed with living hinge 114 and one or more retention member 124 extending from outer surface 103. For example, alignment member 102 may be formed at alignment member distal end 112 and include insertion face 126 and retention face 128.

Systems and methods for elastically averaging mating and alignment systems are described herein. The systems generally include a first component with opposed elastically deformable alignment members positioned for insertion into corresponding opposed alignment apertures of a second component, as well as a third component configured for insertion into a portion of the first component. The mating of the first and second components is elastically averaged over each pair of corresponding alignment member and alignment aperture to precisely mate the components in a desired orientation. The mating of the first and third components is elastically averaged over opposed alignment members to precisely mate the components in a desired orientation. Moreover, the systems include retention members to facilitate retention of the alignment member within the alignment aperture. Accordingly, the described systems and methods facilitate precise alignment of three or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an interior cavity and a pair of opposed alignment members positioned at least partially within the interior cavity;
a second component comprising an inner wall defining a pair of opposed alignment apertures, each alignment aperture configured to receive one of the alignment members to couple the first component and the second component; and
a third component seated within the interior cavity,
wherein the alignment member is an elastically deformable material such that when the opposed alignment members are inserted into the opposed alignment apertures (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

2. The system of claim 1, wherein each alignment member comprises a living hinge such that each alignment member is rotatable between a first position where the first component is not coupled to the second component and a second position where the first component is coupled to the second component.

3. The system of claim 2, wherein in the first position, the opposed alignment members are oriented angularly away from each other, and in the second position, the opposed alignment members are oriented substantially parallel to each other.

4. The system of claim 1, wherein each alignment member comprises a retention member extending therefrom.

5. The system of claim 4, wherein the retention member includes an angularly extending insertion face configured to facilitate insertion of the alignment member into the alignment aperture, and a retention face configured to engage a portion of the second component to prevent removal of the alignment member from the alignment aperture.

6. The system of claim 1, wherein each alignment member comprises a notched portion configured to receive an edge portion of the third component therein.

7. The system of claim 1, wherein the pair of opposed alignment members comprises a first pair of opposed alignment members and a second pair of opposed alignment members, and wherein the pair of opposed alignment apertures comprises a first pair of opposed alignment apertures and a second pair of opposed alignment apertures, the first and second pair of opposed alignment members operatively associated with the first and second pair of alignment members, respectively.

8. A vehicle comprising:
a body; and
an elastically averaged alignment system integrally arranged within the body, the elastically averaged alignment system comprising:
a first component comprising an interior cavity and a pair of opposed alignment members positioned at least partially within the interior cavity;
a second component comprising an inner wall defining a pair of opposed alignment apertures, each alignment aperture configured to receive one of the alignment members to couple the first component and the second component; and
a third component seated within the interior cavity,
wherein the alignment member is an elastically deformable material such that when the opposed alignment members are inserted into the opposed alignment apertures (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

9. The vehicle of claim 8, wherein each alignment member comprises a living hinge such that each alignment member is rotatable between a first position where the first component is not coupled to the second component and a second position where the first component is coupled to the second component.

10. The vehicle of claim 9, wherein in the first position, the opposed alignment members are oriented angularly away from each other, and in the second position, the opposed alignment members are oriented substantially parallel to each other.

11. The vehicle of claim 8, wherein each alignment member comprises a retention member extending therefrom.

12. The vehicle of claim 11, wherein the retention member includes an angularly extending insertion face configured to facilitate insertion of the alignment member into the alignment aperture, and a retention face configured to engage a portion of the second component to prevent removal of the alignment member from the alignment aperture.

13. The vehicle of claim 8, wherein each alignment member comprises a notched portion configured to receive an edge portion of the third component therein.

14. The vehicle of claim 8, wherein the pair of opposed alignment members comprises a first pair of opposed alignment members and a second pair of opposed alignment members, and wherein the pair of opposed alignment apertures comprises a first pair of opposed alignment apertures and a second pair of opposed alignment apertures, the first and second pair of opposed alignment members operatively associated with the first and second pair of alignment members, respectively.

15. A method of manufacturing an elastically averaged alignment system, the method comprising:
fabricating a first component comprising in interior cavity and a pair of opposed alignment member positioned at least partially within the interior cavity;
providing a second component comprising an inner wall defining a pair of opposed alignment apertures, each alignment aperture configured to receive one of the alignment members to couple the first component and the second component;
fabricating a third component; and
seating the third component within the interior cavity,
wherein the alignment member is an elastically deformable material such that when the opposed alignment members are inserted into the opposed alignment apertures, (a) the alignment members elastically deform to an elastically averaged final configuration to facilitate aligning the first component and the second component in a desired orientation, and (b) the third component is secured within the interior cavity between the opposed alignment members to facilitate aligning the first and third components in a desired orientation.

16. The method of claim 15, further comprising forming each alignment member with a living hinge such that each alignment member is rotatable between a first position where the first component is not coupled to the second component and a second position where the first component is coupled to the second component.

17. The method of claim 16, further comprising forming each alignment member such that in the first position, the opposed alignment members are oriented angularly away from each other, and in the second position, the opposed alignment members are oriented substantially parallel to each other.

18. The method of claim 15, further comprising forming each alignment member with a retention member extending therefrom.

19. The method of claim 18, further comprising forming each retention member with an angularly extending insertion face configured to facilitate insertion of the alignment member into the alignment aperture, and a retention face configured to engage a portion of the second component to prevent removal of the alignment member from the alignment aperture.

20. The method of claim 15, further comprising forming each alignment member with a notched portion configured to receive an edge portion of the third component therein.
